(19) United States
(12) Patent Application Publication
(10) Pub. No.: US 2014/0006667 A1
(43) Pub. Date: Jan. 2, 2014

(54) ADAPTIVE HARDWARE INTERRUPT MODERATION

(71) Applicants: Lei Sun, Newport Beach, CA (US); Predrag Kostic, Burnaby (CA)

(72) Inventors: Lei Sun, Newport Beach, CA (US); Predrag Kostic, Burnaby (CA)

(73) Assignee: BROADCOM CORPORATION, Irvine, CA (US)

(21) Appl. No.: 13/534,607

(22) Filed: Jun. 27, 2012

(51) Int. Cl. G06F 13/24; H04L 12/66

(52) U.S. Cl. 710/261; 370/463

(57) ABSTRACT

In one embodiment, a method comprising receiving plural packets; and adaptively adjusting a pushtimer timeout value, packet aggregation threshold, or a combination of both based on a change in filtered rate of the received plural packets.

### TECHNICAL FIELD

The present disclosure is generally related to interrupt moderation.

### BACKGROUND

Host processor (e.g., CPU) interrupts are often generated by network interface controllers (NICs) to request cycles for packet processing. For instance, in the case of an interrupt generation per packet event, the NIC may transmit or receive a given packet and generate an interrupt responsive to such an event. The CPU then suspends current activity to handle the interrupt, which may include saving state information, executing an interrupt handler for the NIC, etc. Upon handling the interrupt, the CPU resumes its activity. However, interrupt generation for every packet event (e.g., receive or transmission) diverts the CPU from other activities, which results in less than optimum use of CPU processing capacity.

Interrupt moderation may be used as an alternative to per packet interrupt events. Interrupt moderation refers to a mechanism where the CPU is interrupted for every received N (e.g., plural) packets instead of for every packet. In network interface controllers (embedded or standalone), interrupt moderation may reduce host processor interrupts, saving the CPU from constant context switching and therefore reducing the CPU load. Interrupt moderation is typically deployed by the various manufacturer NICs. In some conventional systems, two interrupt moderation mechanisms may be used, such as a packet count threshold mechanism and a “push timer” mechanism. The packet count threshold generates an interrupt toward the CPU once a programmed number of packets are received. The “push timer” (or “packet timer,” as sometimes referred to in the literature) is used in cases where a traffic pattern deviates from the designed-for (pre-defined) pattern (e.g., less packets are received than expected or, a connection is stopped, etc.), resulting in an interrupt threshold not being reached within the pre-defined period. Registers are typically used to program this feature, and such programming is performed during the NIC initialization by making assumptions about the traffic.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of an example embodiment of an adaptive hardware interrupt moderation system comprising a network interface controller.

FIG. 2 is a block diagram of an example embodiment of a network interface controller.

FIG. 3 is a block diagram that illustrates an example operation of an example embodiment of an adaptive hardware interrupt moderation system.

FIG. 4 is a flow diagram that illustrates an example embodiment of an adaptive hardware interrupt moderation method.

### DETAILED DESCRIPTION

Disclosed herein are certain embodiments of adaptive hardware interrupt moderation systems and methods that intelligently adjust an interrupt rate based on traffic patterns. One mechanism employed by one or more embodiments is to track and learn the traffic pattern in real time and, dynamically tune various parameters through hardware. Dynamically-tuned parameters include a packet aggregation threshold and a push timer timeout value. Packet aggregation threshold techniques generally involve delaying interrupt generation until a pre-defined number of packets are received. Push timer timeout techniques generally involve forcing interrupt generation in low packet throughout scenarios if the received number of packets does not cross a threshold in a certain amount of time.

Digressing briefly, existing software systems set various interrupt moderation parameters at software/driver design time, which involves assuming a typical or worst case traffic pattern. However, real-life traffic patterns comprise periods of high traffic intermixed with periods of low traffic. In other words, network traffic is often unpredictable. Hence, pre-set, fixed parameters may result in sub-optimal performance in some circumstances. For instance, in at least one conventional software approach, in low/moderate traffic situations, if a host processor has enough power and is processing packets, there may be only a few packets available. If a weight factor (e.g., threshold for generating an interrupt) is relatively large, the interrupt rate may not be reduced to the rate it should be. For the software approach in a high packet rate traffic situation, the weight should be increased to process more packets. However, if the weight factor is fixed at driver design time, it cannot be adjusted at run-time.

Conventional hardware approaches using packet aggregation (e.g., packet threshold) and push timer techniques also have similar shortcomings associated with fixed parameters. For instance, packet threshold is typically used in high packet rate situations, whereas the timer is typically used in low packet rate situations. Packet threshold is set to achieve a desired maximum interrupt rate and the timer is used in low packet situations to bound packet processing delay (e.g., latency). Typically, the timeout is longer than the time needed to receive a threshold amount of packets at a high rate. So in general, these two mechanisms address packet processing/interrupt issues in a less-than-optimal manner. For example, a threshold that is set for a high packet rate may introduce processing latency for moderate packet rates. Further, a timeout that is set for low packet rates may affect applications that generate low rate traffic but are sensitive to processing delay and so on.

As explained above, whether for conventional software or hardware approaches, all of these parameters are tuned at software/driver design time under certain assumptions, and hence performance is not optimal when traffic is not according to the designed-for pattern.

This assumed, fixed parameter design of existing systems may also lead to performance deficiencies in certain streaming protocols. For instance, consider a media server gateway serving multiple streaming sessions, including peer-to-peer (P2P) sessions. If the traffic rate is high, it is reasonable to set an “aggregation threshold” to a higher value. One may think that setting a higher packet threshold implies a longer push timer timeout, since in this case, the packet threshold is crossed first before the push timer expires. However, if a streaming session uses encryption such as DTCP-IP, during session initialization, a Round Trip Time (RTT) is measured, where a burst of a few packets is sent out (less than the “aggregation threshold”) and an immediate response is expected. If the “aggregation threshold” is not reached and the push timer timeout is set to a larger value, the response latency is large, causing the RTT measurement to fail.

Certain embodiments of adaptive hardware interrupt moderation systems, through real-time adaptive adjustment of various parameters, mitigate or eliminate one or more of the aforementioned shortcomings. For instance, one embodiment reduces packet delivery latency in the low packet rate case, while maximizing aggregation count in the high packet rate case. In other words, by maximizing packet aggregation count and minimizing packet delivery latency and reducing interrupt count, one or more embodiments of adaptive hardware interrupt moderation systems improve CPU utilization by optimizing interrupt rate, enabling a reduction in interrupt rate (and saving power) while providing a balance between performance and response time.

Having summarized certain features of one or more embodiments of adaptive hardware interrupt moderation systems, reference will now be made in detail to the description of the disclosure as illustrated in the drawings. While the disclosure will be described in connection with these drawings, there is no intent to limit it to the embodiment or embodiments disclosed herein. Further, although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

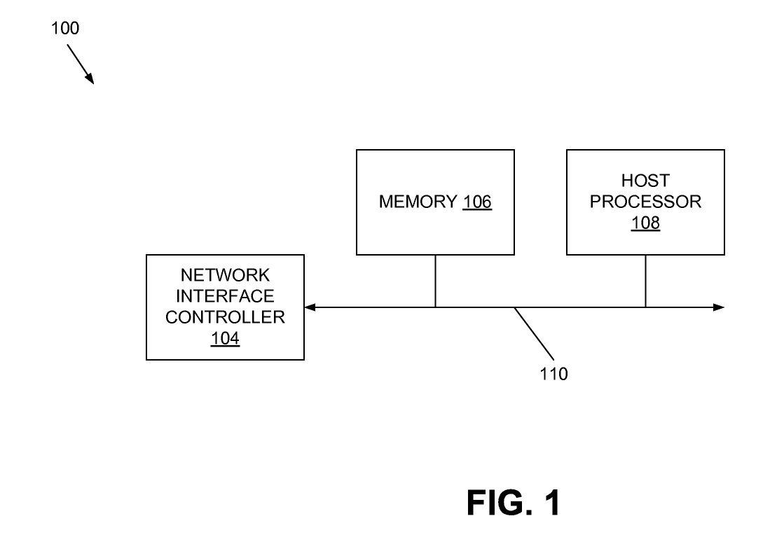

Referring to FIG. 1, shown is a block diagram of an example embodiment of an adaptive hardware interrupt moderation system 100. The example adaptive hardware interrupt moderation system 100 comprises a MAC controller, such as a network interface controller 104, coupled to a memory 106 and a host processor 108 over a bus 110. Although the adaptive hardware interrupt moderation system 100 is depicted in FIG. 1 as comprising several components, some embodiments of a hardware interrupt moderation system may include a subset of the components shown in FIG. 1 or additional components in some embodiments. One having ordinary skill in the art should appreciate in the context of the present disclosure that other arrangements of components for interrupt moderation according to the disclosed embodiments may be employed and hence are contemplated to be within the scope of the disclosure. The adaptive hardware interrupt moderation system 100 may be embedded on a chip as part of an on-chip network, such as embedded in a system on a chip (SoC) for an electronic appliance, such as a set top box, DSL or cable modem that supports MoCA (e.g., for home media distribution), Ethernet, and/or Gigabit Ethernet among other network environments. In some embodiments, the adaptive hardware interrupt moderation system 100 may be a stand-alone unit, such as for a gateway, server, computer, etc.

The network interface controller 104 receives the packets (e.g., Ethernet packets) that arrive and provides the same to the memory 106 via direct memory access (DMA) or other known techniques for packet transfer. The network interface controller 104 performs adaptive interrupt moderation processing as disclosed further below, and generates an interrupt for delivery to the host processor 108 via the bus 110 (e.g., over an interrupt line). The bus 110 includes control and data paths, though in some embodiments, separate conductive paths may be used for these purposes. The host processor 108 receives the interrupt, which essentially signals to the host processor 108 that one or more packets are ready for processing in a given DMA location. The host processor 108 then processes the packets in known fashion.

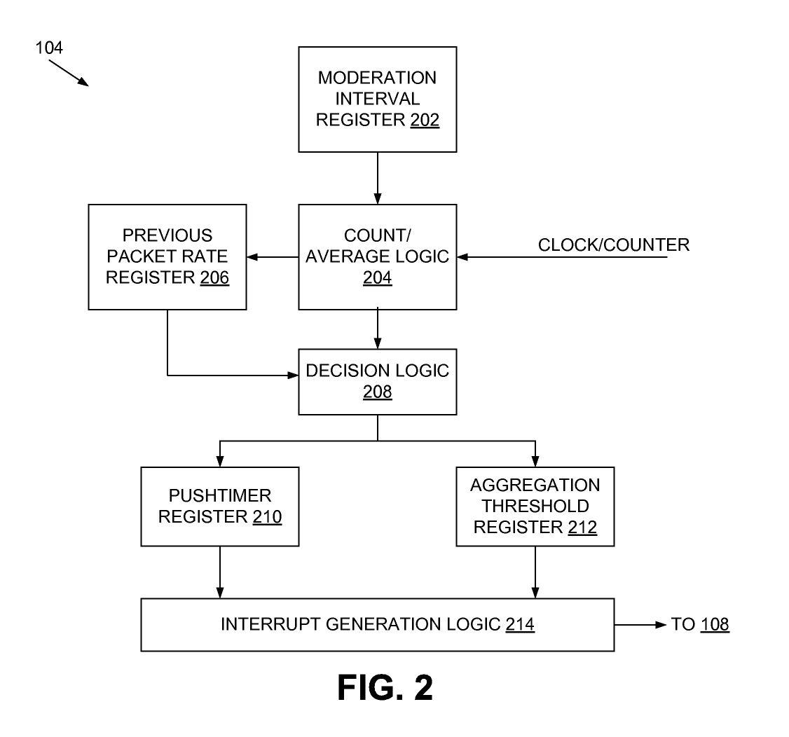

Having broadly described an embodiment of an adaptive hardware interrupt moderation system 100, attention is directed to FIG. 2, which shows an embodiment of the network interface controller 104 generally depicted in FIG. 1. One having ordinary skill in the art should appreciate in the context of the present disclosure that the example network interface controller 104 depicted in FIG. 2 is merely illustrative, and that other arrangements of components, including fewer or additional components, may be used in some embodiments and hence are contemplated to be within the scope of the disclosure. For instance, count/average logic 204 is described below in the context of exponential weighted averaging, though it should be appreciated within the context of the present disclosure that such an averaging function represents one example, among many, of what is generally referred to herein also as a rate filtering function. However, other rate filtering functions, such as median filtering, among other well-known averaging functions, may be used in some embodiments, and hence are contemplated to be within the scope of the disclosure. The network interface controller 104 comprises a moderation interval register 202, count/average logic 204, a previous packet rate register 206, decision logic 208, a pushtimer register 210, aggregation threshold register 212, and interrupt generation logic 214. Note that additional registers may be used in some embodiments, such as to store initial, one-time programmed values (e.g., a maximum aggregation count).

The moderation interval register 202 stores a parameter that controls how often the network interface controller 104 computes a rate filtering function (e.g., computes the average of the packet count, also referred to as the average packet rate) and adjusts the interrupt rate. Software is used to set up the moderation interval register 202, and hence comprises a configurable value. In one embodiment, the moderation period is set according to a millisecond scale, though other scales may be used depending on the design conditions. The count/average logic 204 comprises hardware logic (e.g., circuitry) that receives a clock/counter to enable a count of each received packet. That is, the receipt of each packet results in the generation (by the network interface controller 104) of a packet count. The count/average logic 204 computes the average number of packets received based on the moderation period stored in the moderation interval register 202, and provides the same to the decision logic 208. For instance, if the moderation period is set to 10 milliseconds, the count/average logic 204 averages the number of received packets every 10 milliseconds. The previous packet rate register 206 comprises a computed average packet count based on a prior moderation period, the computed average based on computations by the decision logic 208 as described below.

The decision logic 208 receives the average packet count (from a prior moderation period) from the previous packet rate register 206 and a current packet rate from the count/average logic 204. In one embodiment, in each moderation period, the decision logic 208 computes an exponential weighted average. For instance, let “avg” denote the average packet rate computed in the previous moderation period (e.g., stored in previous packet rate register 206). Then, the average may be expressed according to Equation (1) below as follows:

avg=(1−w)*avg+w*current_packet_rate, (1)

where w is a weighting factor less than one (1), and current_packet_rate is the current packet rate provided by the count/average logic 204.

The newly computed average is used to program the pushtimer value in the pushtimer register 210 and/or the aggregation threshold in the aggregation threshold register 212. In other words, either of registers 210 or 212 or a combination of both may be affected by the result of the averaging function. In one embodiment, w may be expressed as 1/2ⁿ replacing multiplication with a shift operation that is simple to implement in hardware. If higher precision is required, w may be expressed as N/2ⁿ, where N=1, 2, 2ⁿ⁻¹. Such a representation replaces a floating point multiplication with an integer multiplication, simplifying the hardware. As noted above, this is one example of a rate filtering function, whereas other rate filtering functions may be used in some embodiments.

In some embodiments, an adjustment in the interrupt rate (and hence adjustment to the pushtimer value or aggregation threshold) does not occur unless there is a threshold difference in the filtered rate (e.g., average) rate from the previous moderation period to the current moderation period.

The pushtimer and/or aggregation threshold register values are used to determine when the interrupt generation logic 214 delivers an interrupt to the host processor 108.

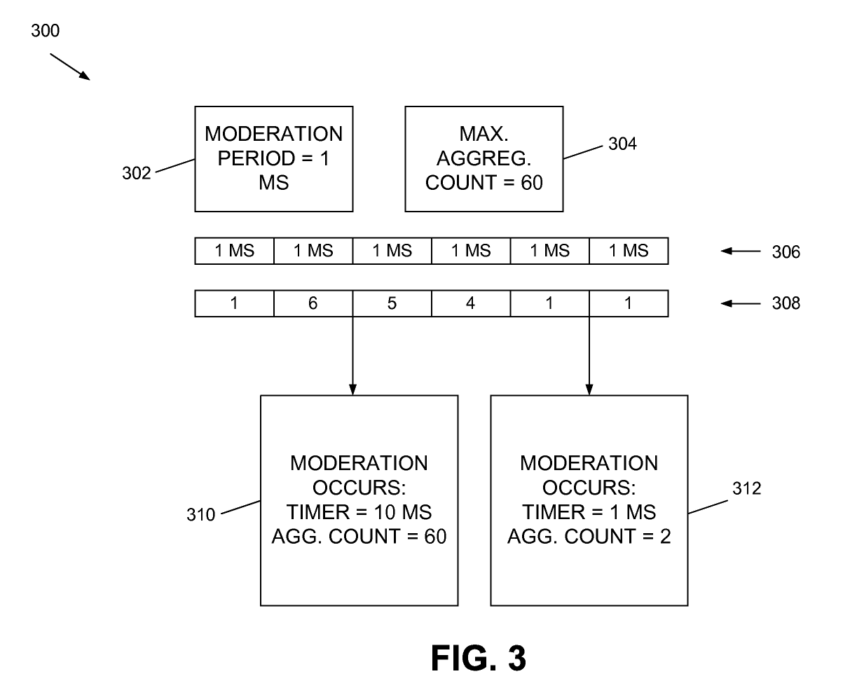

Having described one embodiment of a network interface controller 104, attention is now directed to FIG. 3, which illustrates an example operation 300 of the network interface controller 104 as it implements interrupt moderation according to at least one of the disclosed embodiments. The operation includes initially set (programmed) values for moderation period 302 (e.g., one (1) millisecond or ms) and maximum aggregation count 304 (e.g., 60), such as programmed in registers in the network interface controller 104. Also shown is an illustration of the time slices 306 according to the moderation period (e.g., one (1) ms each, though not limited to this example moderation period), and beneath that representation, the receive packet rate 308 that is measured (e.g., measured before computation of the average) at each moderation period. As mentioned above, the selected moderation period is illustrative of one example among many, and it should be appreciated within the context of the present disclosure that other moderation periods may be selected, depending for instance on the application. As described above, an average (e.g., weighted exponential average, among other well-known averaging mechanisms) is computed for each moderation period. As depicted in FIG. 3, the first one (1) ms moderation period in 306 has a corresponding measured packet rate of one (1), whereas the next one (1) ms moderation period has a measured packet rate of six (6). Note that adaptive interrupt moderation occurs (e.g., is implemented) whereby the pushtimer register value (e.g., value in register 210 in FIG. 2) is adjusted to ten (10) ms and the aggregation threshold register value (e.g., value in register 212 in FIG. 2) is adjusted to a count of sixty (60), as reflected in block 310. The large jump in measured packet rate (e.g., from 1 to 6) is filtered out by the weighted exponential averaging function to avoid a constant changing of parameters. Stated differently, one or both parameters may be adjusted based on the current average rate (e.g., the filtered rate, versus instantaneous rate). Hence, the interrupt rate is adaptively adjusted based on the real-time change in packet rate conditions.

Continuing with the example, the next two moderation periods have corresponding measured packet rates of five (5) and four (4), which do not represent in this example enough change to warrant adaptive interrupt moderation (as filtered by the weighted exponential averaging function). In other words, the filtered rate changes slowly (e.g., packet rates from five (5) to four (4)), depending for instance how “w” is selected. In the changes from one (1) to six (6), there is a filtered rate that changes significantly. Thus, a change in rate from X to Y packets/second may translate into a threshold Z and/or a pushout timer W, which is equivalent to using a delta to increase or decrease the threshold or timer values. However, the next moderation period drops to rate of one (1), which prompts adaptive interrupt moderation as reflected in block 312. As shown in block 312, the pushtimer and aggregation threshold values are adjusted downward to one (1) ms and two (2), respectively. In other words, the packet rate change from four (4) to one (1) signify decreased traffic, and hence adjustment of the parameters. It should be appreciated within the context of the present disclosure that the example depicted in FIG. 3 is merely illustrative, and that other scenarios and thresholds for adaptive interrupt moderation implementation are contemplated to be within the scope of the disclosure.

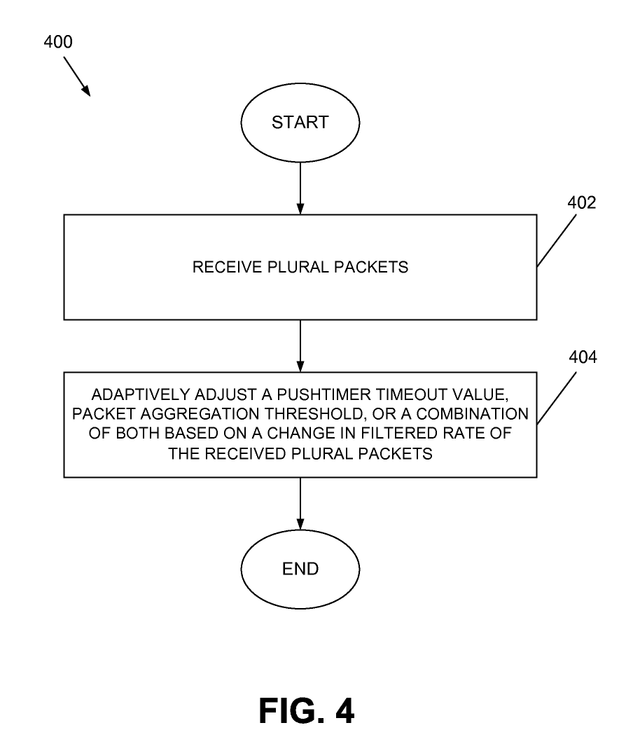

It should be appreciated within the context of the present disclosure that one embodiment of adaptive hardware interrupt moderation method 400, depicted in FIG. 4, comprises receiving plural packets (402); and adaptively adjusting a pushtimer timeout value, packet aggregation threshold, or a combination of both based on a change in filtered rate of the received plural packets (404). In one embodiment, the method 400 further comprises generating an interrupt based on the adjusted pushtimer timeout value, the adjusted packet aggregation threshold, or the combined adjusted values. The method 400 also comprises counting the received plural packets, and performing a rate filtering function for the received plural packets according to a configurable moderation period to provide a rate filtered packet rate, wherein the moderation period determines how often the rate filtering function is to be determined. In one embodiment, the adjusting is responsive to either a difference or a threshold difference in the rate filtered packet rate and the current packet rate. The rate filtering function comprises a weighted exponential averaging function, or in some embodiments, other types of rate filtering functions such as median, mean, among others.

As described above, conventional moderation interrupt systems use fixed values and defined assumptions when configuring the interrupt system at start-up. Such systems typically operate with sub-optimal performance. For example, in high packet count cases, the interrupt rate may be still high leading to suboptimal CPU utilization. Similarly, as the push timer is set to fixed value, if this value is too low, the interrupt rate may be unnecessarily high and if the value is too large, it may affect protocols that measure or rely on round-trip latency. Certain embodiments of adaptive hardware interrupt moderation systems and methods address all or part of these shortcomings through the use of real-time adaptation to interrupt moderation parameters.

The adaptive hardware interrupt moderation systems described herein may be implemented in hardware, software (e.g., including firmware), or a combination thereof. To the extent one or more components of certain embodiments of the adaptive hardware interrupt moderation system is implemented in hardware, the hardware may include any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. To the extent one or more components of certain embodiments of adaptive hardware interrupt moderation systems in software, the software is stored in a memory and is executed by a suitable instruction execution system.

Any process descriptions or blocks in flow diagrams should be understood as representing modules, segments, or portions of code which include one or more executable instructions for implementing specific logical functions or steps in the process, and alternate implementations are included within the scope of the disclosure in which functions may be executed out of order from that shown or discussed, including substantially concurrently or in reverse order, depending on the functionality involved, as would be understood by those reasonably skilled in the art.

It should be emphasized that the above-described embodiments of the present disclosure are merely possible examples of implementations, merely set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

At least the following is claimed:

1. A system, comprising:
a network interface controller configured to:
receive plural packets; and
adaptively adjust a pushtimer timeout value and packet aggregation threshold based on a change in filtered rate of the received plural packets.

2. The system of claim 1, wherein the network interface controller comprises hardware logic configured to:
count the received plural packets;
average the received plural packets according to a configurable moderation period; and
store the average packet rate in a register.

3. The system of claim 2, wherein the moderation period comprises a value programmed into a register, the moderation period defining how often the average is to be determined.

4. The system of claim 2, wherein the network interface controller comprises decision logic configured to:
adjust the pushtimer timeout value and the packet aggregation threshold responsive to a difference in the average packet rate and a current packet rate.

5. The system of claim 2, wherein the network interface controller comprises decision logic configured to:
adjust the pushtimer timeout value and the packet aggregation threshold responsive to a threshold difference in the average packet rate and a current packet rate.

6. The system of claim 1, wherein the network interface controller comprises a register for storing the pushtimer timeout value and a register for storing the packet aggregation threshold.

7. The system of claim 1, wherein the network interface controller comprises interrupt generation logic configured to generate an interrupt based on the adjusted pushtimer timeout value and the adjusted packet aggregation threshold.

8. The system of claim 7, further comprising a host processor configured to receive and handle the interrupt.

9. The system of claim 1, wherein the network interface controller is configured to adaptively adjust the pushtimer timeout value and the packet aggregation threshold subsequent to initialization of the network interface controller.

10. The system of claim 1, wherein the network interface controller is a standalone unit.

11. The system of claim 1, wherein the network interface controller is an embedded unit.

12. The system of claim 1, wherein the plural packets comprise Ethernet packets.

13. A method, comprising:
receiving plural packets; and
adaptively adjusting a pushtimer timeout value, packet aggregation threshold, or a combination of both based on a change in filtered rate of the received plural packets.

14. The method of claim 13, further comprising generating an interrupt based on the adjusted pushtimer timeout value, the adjusted packet aggregation threshold, or the combined adjusted values.

15. The method of claim 13, further comprising:
counting the received plural packets; and
performing a rate filtering function for the received plural packets according to a configurable moderation period to provide a rate filtered packet rate, wherein the moderation period determines how often the rate filtering function is to be determined.

16. The method of claim 15, wherein the adjusting is responsive to either a difference or a threshold difference in the rate filtered packet rate and a current packet rate.

17. The method of claim 16, wherein the rate filtering function comprises an averaging function.

18. A network interface controller, comprising:
a first register comprising a configurable packet aggregation threshold that sets a limit on a maximum number of packets the network interface controller receives before generating an interrupt;
a second register comprising a configurable moderation period that controls how often the network interface controller computes a rate filtering function and adjusts an interrupt rate; and
hardware decision logic that adaptively adjusts a pushtimer timeout value, the packet aggregation threshold, or a combination of both based on a change in filtered rate of received plural packets.

19. The network interface controller of claim 18, wherein the hardware decision logic is configured to:
perform the rate filtering function for the received plural packets according to the moderation period to provide a rate filtered packet rate; and
adjust responsive to either a difference or a threshold difference in the rate filtered packet rate and a current packet rate.

20. The network interface controller of claim 18, further comprising interrupt generation logic configured to generate an interrupt based on the adjusted pushtimer timeout value, the adjusted packet aggregation threshold, or the combined adjusted values.
